(19) United States
(12) Patent Application Publication
(10) Pub. No.: US 2008/0102928 A1
(43) Pub. Date: May 1, 2008

(54) VIDEO MICROPROCESSOR GAME WITH SPINNING REELS

(76) Inventor: Keiran Daley, Penrith (AU)

Correspondence Address: SNELL & WILMER LLP (OC), 600 ANTON BOULEVARD, SUITE 1400, COSTA MESA, CA, 92626, US

(21) Appl. No.: 11/874,110

(22) Filed: Oct. 17, 2007

(30) Foreign Application Priority Data
Oct. 19, 2006 (AU) 2006905828

(51) Int. Cl. G06F 17/00

(52) U.S. Cl. 463/20

(57) ABSTRACT

An electronic gaming machine provides a base game comprising a multi-line spinning reel game and a random prize awarding feature which selectively provides a feature outcome. The machine is arranged to offer the feature outcome when a game has achieved a trigger condition, the machine including trigger detection arranged to test for the trigger condition and to initiate the feature outcome when the trigger condition occurs. The trigger condition may be determined by an event having a probability related to the number of lines played in the respective game. The feature outcome is provided as a feature game phase which comprises one or more free respins and feature game phase prizes are paid according to predetermined feature game phase rules. In a feature game phase all the reels are respun once and after the first free respin, and after any subsequent free respin, any reel strip displaying a symbol in a predefined manner is held in place for a remainder of the feature game phase. At the completion of the last respin, the symbols on display are evaluated and if a prize-winning combination exists a prize is awarded according to the rules applying to the feature game phase and the feature phase discontinues and the base game is reinstated.

### INTRODUCTION

This invention relates generally to gaming devices, and in particular, the invention relates to new triggers and a new bonus mode play feature for a gaming device.

### BACKGROUND TO THE INVENTION

Spinning reel gaming machines or slot machines are well known in many jurisdictions. Such machines may have physical reels or pseudo-reels displayed on a video display screen. Over recent years increasing numbers of such machines have been legalized for operation in particular venues. The operation of such machines is subject to a legislative and regulatory milieu which, among other matters, defines minimum percentage payout ratios; bet value limits and so forth. Game designers must therefore design their games to satisfy these statutory requirements.

With the growth in the number of machines and growth in the jurisdictions permitting their operation, the competition between suppliers of the games is vigorous. In an effort to increase sales, suppliers of machines are constantly trying to design games that are more popular with players than games designed by competitors. Operators of venues in which the machines are placed closely attend to player reactions to games with the popularity of games being an important element of this attentiveness.

Game designers use various statistical models in an effort to attract and maintain player interest. Sometimes presentation properties have been used per medium of enhanced graphics, novel audio routines, animations, use of special themes and the like. Alternately, game-function properties (that is statistical/mathematical characteristics of games) have been the focus.

Game-function properties have included game bonus or feature subsets in the attempt to enhance popularity with players and, as well, to attract new players. As an example, base games have been designed with so called ‘free game’ triggers. When such a trigger event occurs during the course of a base game, a series of free games or respins are awarded to a player during which prizes and the probabilities of winning prizes may be different to the base game values and often at enhanced levels to that of the Base Game.

Multi-Line Spinning Reel Gaming Machines

In recent years slot machine games have been devised on which it is possible for players to activate more than one play line per game. (as described, for example, in U.S. Pat. No. 6,093,102).

Games that enable multiple play lines to be activated are effectively enabling the simultaneous activation of multiple separate games. When, for example, a player activates 5 play lines, that player is, with one action, initiating 5 separate but simultaneous single line games.

Some of these separate games may contain shared or common event outcomes such as defined “scatter” outcomes. Despite such a common subset to each game, linear game configurations are essentially discrete. For convenience, the descriptions that follow refer to games in terms of spinning reel multiple play line displays.

With modern video games that simulate spinning reels, the reel spin is merely a display to advise a player whether a win or a loss has occurred. The game outcomes on such devices are determined by a computer program embedded in the electronic and processing architectures of the device being played.

Because games are designed to make a profit for their operator, all games are designed such that there is an expectation that the Return to Players will, in the long term, be less than 100% of total value bet on games.

Linearity

However defined for any particular game, a play line is a singularity. It defines a unique pattern of predefined reel positions on a game display medium. While we have stated above that a multi-line game is effectively plurality of single line games played simultaneously, for the purposes of this specification, a game is a play in which reels are spun (irrespective of the number of play lines activated). Players may elect to play more than one play line per game and, additionally, may elect to stake one or more bet units per play line per game. For the purposes of this specification, the term “respin” is used to refer to a free spin of one or more reels in a game.

Frequency Expectation.

A predefined linear combination of symbols has an expected frequency of occurrence on a single play line. For example, on a game that has 5 reels and only 1 particular symbol among others on each of the reels, the expected frequency of occurrence is 1 out of the total possible unique occurrences of reel position combinations. To further illustrate this, a possible Symbol distribution over 5 reels for a game is shown in Table 1:

TABLE 1

| | Reel | | | | |
|---|---|---|---|---|---|
| Symbol | 1 | 2 | 3 | 4 | 5 |
| Koala | 1 | 1 | 1 | 1 | 1 |
| Elephant | 1 | 1 | 4 | 4 | 2 |
| Zebra | 3 | 4 | 2 | 4 | 4 |
| Ace | 4 | 3 | 4 | 4 | 5 |
| King | 4 | 5 | 3 | 5 | 4 |
| Queen | 4 | 4 | 4 | 4 | 5 |
| Jack | 5 | 6 | 4 | 3 | 3 |
| Ten | 7 | 4 | 5 | 2 | 5 |
| Eagle | 1 | 1 | 1 | 1 | 1 |
| Crown | 0 | 1 | 2 | 2 | 0 |
| | 30 | 30 | 30 | 30 | 30 |

The total possible combination of reel positions that can occur on a single play line is calculated as 24,300,000. That is 30×30×30×30×30=24,300,000. (Referred to as ‘cycle’)

The probability of getting 5×Queens in a single predefined alignment is 1,280/24,300,000. (that is: [4×4×4×4×5]/24,300,000).

Should a player have chosen to play a game with more than one play line, the probability of 5×Queens appearing in a game is a multiple of the number of lines chosen in the play. For a game played with 20 play lines, the expected frequency of 5×Queens per game would be 25,600 (i.e. 1,280×20). Its probability of occurrence per game with 20 lines in play would be (1,280×20)/24,300,000.

“Scatter” Events

Unlike linearity, the scatter pattern does not require a single alignment pattern of symbols. It may include any predefined linear pattern as a subset, but is not restricted by it. In effect, a scatter pattern traditionally defined includes all possible symbol linear combination patterns which include one position in each column of the display. From the above symbol distribution, 5×‘Eagle’ in scatter mode would be calculated on a 5 column×3 row display matrix as 3×3×3×3×3×3=243. On a 5 column×4 row display its expected frequency would be 1,024 (that is 4×4×4×4×4=1,024).

The expected frequency of a scatter mode combination of symbols does not vary per game with the number of play lines activated by a player.

The following comparison in Table 2 illustrates the expected frequency difference per game and per lines played for the combinations mentioned (assuming a 5 column×3 row display).

TABLE 2

| | | Expected Frequency |
|---|---|---|
| | Expected Frequency | Per Game of |
| Lines Played per Game | Per Game of 5 × Queen | 5 × scattered Eagle |
| 1 | 1,280 | 243 |
| 2 | 2,560 | 243 |
| 3 | 3,840 | 243 |
| 10 | 12,800 | 243 |
| 20 | 25,600 | 243 |

The expected frequency of linear events increases per game in direct proportion to the number of play lines activated

Game designers try to maximize what might be termed ‘player sensitivity indices’. For example, it is acknowledged that with low denomination multi-line games (1c, 2c and 5c bet unit values) high volatility is one ingredient that tends to be associated with player popularity. This volatility can be precisely measured as a statistical index and is often expressed as the standard deviation for a game. The standard deviation is simply an index of variability. Given the number of games played, for example, it can be used to measure the degree to which a game is likely to vary from its expected average (the Return to Player Percentage or RTP). By way of illustration, a game with a standard deviation of 6.8 and a RTP setting of 90.8% would be expected to operate in the ranges shown for the level of plays indicated in Table 3 (using the Standard Normal distribution and a 95% confidence interval):

TABLE 3

| Simple Games | Minimum RTP | Maximum RTP |
|---|---|---|
| 10,000 | 77.5% | 104.1% |
| 50,000 | 84.8% | 96.8% |
| 200,000 | 87.8% | 93.8% |

The simple observation to be made is that the bigger the standard deviation, the greater will be the ranging around the RTP. That is, the greater volatility. By way of contrast, another game with the same RTP but with a standard deviation of 12.6 would be expected to operate in the ranges shown in Table 4 (again, using the Standard Normal distribution and a 95% confidence interval):

TABLE 4

| Simple Games | Minimum RTP | Maximum RTP |
|---|---|---|
| 10,000 | 66.1% | 115.5% |
| 50,000 | 79.8% | 101.8% |
| 200,000 | 85.3% | 96.3% |

There are other player sensitive indices that game designers consider. The Base Game ‘hit rate’ is one. This is a simple measure of the average number of games for a win to occur (assuming 1 credit unit bet and 1 play line activated). For a game with a cycle of 10,000,000 and 1,250,000 expected wins within that cycle, the hit rate is 8—often expressed as 1 in 8, or 12.5%. As illustrated in Table 2 above, the hit rate percentage tends to increase as a multiple of the number of lines played in a game given that win-events or ‘hits’ are linear.

Game volatility and Game hit rate are normally inimical to one another. To increase the hit rate while maintaining the overall Player Return Percentage can be done by increasing the relative frequency of lower valued prize wins. The normal consequence of this is to decrease the volatility by lowering the standard deviation. Therefore these two player sensitivity indices are generally in tension whenever attempts are made to maximize both indices at the same time.

### SUMMARY OF THE INVENTION

According to a first broad aspect, an electronic gaming machine is provided having a base game comprising a multi-line spinning reel game and a random prize awarding feature to selectively provide a feature outcome, the machine being arranged to offer the feature outcome when a game has achieved a trigger condition, the machine including trigger detection arranged to test for the trigger condition and to initiate the feature outcome comprising a feature game phase when the trigger condition occurs, and the feature game phase characterised in that:

feature game phases each comprise one or more free respins;

feature game phase prizes are paid according to predetermined feature game phase rules;

in a feature game phase all the reels are respun once;

after the first free respin, and after any subsequent free respin, any reel strip displaying a symbol in a predefined manner is held in place for a remainder of the feature game phase;

at the completion of the last respin, the symbols on display are evaluated and if a prize-winning combination exists a prize is awarded according to the rules applying to the feature game phase and the feature phase discontinues and the base game is reinstated.

According to a second broad aspect, a method of operating an electronic gaming machine is provided, wherein the gaming machine has a base game comprising a multi-line spinning reel game and a random prize awarding feature to selectively provide a feature outcome, the method comprising offering the feature outcome when a game has achieved a trigger condition, the machine including trigger detection arranged to test for the trigger condition and the feature outcome comprising a feature game phase, the method comprising initiating the feature game phase when the trigger condition occurs, the method characterised in that:

each feature game phase is operated to provide one or more free respins;

when a prize is won by a player in the feature game phase, the prize is paid according to predetermined feature game phase rules;

when the feature game phase is initiated all the reels are respun once;

after the first free respin, and after any subsequent free respin, any reel strip displaying a symbol in a predefined manner is held in place for a remainder of the feature game phase;

at the completion of the last respin, the symbols on display are evaluated and if a prize-winning combination exists a prize is awarded according to the rules applying to the feature game phase and the feature phase discontinues and the base game is reinstated.

In one embodiment, subsequent free respins are initiated to spin un-held reels while there are un-held reels remaining. Typically there will be a predetermined maximum number of respins, the maximum being no less than two respins.

In embodiments of the electronic gaming machine, the symbols on display may be evaluated at the completion of each respin, and if a prize-winning combination exists a prize is awarded according to the rules applying to the feature game phase.

Feature outcome respins may use a set of reel strips comprising a plurality of predefined reel strips, there being one for each pseudo-reel for each respin wherein each respin may be assigned a specific set of reel strips and wherein:
a) the number of symbol positions on each reel strip may be predefined; and
b) the symbols positions on each reel strip of each set of pseudo-reels may be populated by a single symbol (and/or its substitute) with provision for some symbol positions on each predefined reel strip to have no symbol assigned.

Preferably, in the set of reel strips, the reel strips for each pseudo-reel are identified similarly and before each free respin, subsequently to the first respin, any reel which is not held may be replaced by a similarly identified reel strip from the next set of reels strips.

A specific symbol (and/or its substitute) is used in each specific instance of a feature game phase and the specific symbol is selected according to predefined game rules. The selection of the special symbol may occur immediately following the occurrence of a trigger.

If more than 1 defined trigger occurs in a single game, feature phase implementations equal to the number of distinct triggers may be serially activated.

The trigger may be a combinational trigger, relying on a predefined outcome combination of symbols occurring during a base game. Alternatively the trigger may be a random trigger unrelated to outcome of the base game.

According to a third broad aspect, an electronic gaming machine is provided having a base game comprising a multi-line spinning reel game and a random prize awarding feature to selectively provide a feature outcome, the machine being arranged to offer the feature outcome when a game has achieved a trigger condition, the machine including trigger detection arranged to test for the trigger condition and to initiate the feature outcome when the trigger condition occurs, the trigger condition being determined by an event having a probability related to the number of lines played in the respective game.

According to a fourth broad aspect, a method of operating an electronic gaming machine is provided, the electronic gaming machine having a base game comprising a multi-line spinning reel game and a random prize awarding feature to selectively provide a feature outcome, the machine being arranged to offer the feature outcome when a game has achieved a trigger condition, the machine including trigger detection arranged to test for the trigger condition and to initiate the feature outcome when the trigger condition occurs, and the method comprising testing for the trigger condition and initiating the feature outcome when the trigger condition occurs, wherein the trigger condition is determined by occurrence of an event having a probability related to the number of lines played in the respective game.

Testing for the trigger condition will typically occur during a base game on the machine, and the feature outcome initiated by the trigger condition may be the awarding of two or more feature games. In fact the number of actual feature game respins played is outcome dependant and might be as few as one respin if a winning symbol is spun up on every reel in the first feature respin, but if more than one respin is awarded the outcome may be determined multiple times even if only one actual respin occurs. The number of respins played is dependant upon the cumulative outcome of the previous respins and could be any number up to a predetermined maximum number of respins determined in the game design. However the maximum number will never be less than two respins. The base game may be a standard game normally offered on the machine and each feature game may be a jackpot game associated with a special jackpot prize.

In one embodiment the trigger condition is determined by selecting a random number from a predetermined range of numbers to be associated with each base game, and a set of numbers selected from the predetermined range of numbers is allotted to the game, the size of the set of allotted numbers being related to the number of lines played in the respective game, and in the event that one of the numbers allotted to the game matches the randomly selected number, indicating that the trigger condition has occurred. However other embodiments may use variations on this arrangement. For example, the trigger condition may be determined by selecting a random number from a predetermined range of numbers to be associated with each base game, and a set of numbers selected from the predetermined range of numbers is allotted to the game as before, but in this example the size of the set of allotted numbers is inversely related to the number of lines played in the respective game, and in the event that none of the numbers allotted to the game matches the randomly selected number, indicating that the trigger condition has occurred.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

An embodiment of an electronic gaming machine, game and method will now be described by way of example with reference to the accompanying drawings in which;

FIG. 1 shows a perspective view of a first style of gaming machine, suitable for use in systems implementing embodiments of the present invention;

FIG. 2 shows a detail of gaming machine of FIG. 1;

FIG. 3 shows a perspective view of a second style of gaming machine, suitable for use in systems implementing embodiments of the present invention;

FIG. 4 shows a block diagram of a control circuit of the gaming machines of FIGS. 1 and 3;

FIG. 5 is a first flowchart illustrating a method of operating feature game phase;

FIG. 6 is a second flowchart illustrating a method of operating feature game phase;

FIG. 7 is a third flowchart illustrating a method of operating feature game phase;

FIGS. 8, 9 and 10 show characteristics of first second and third reel strip sets respectively for one possible feature game; and

FIGS. 11, 12, 13, and 14 illustrate reel strip displays at the start and after first, second and third respins respectively in one possible feature game.

### DETAILED DESCRIPTION OF AN EMBODIMENT OF AN ELECTRONIC GAMING MACHINE, SAME AND METHOD

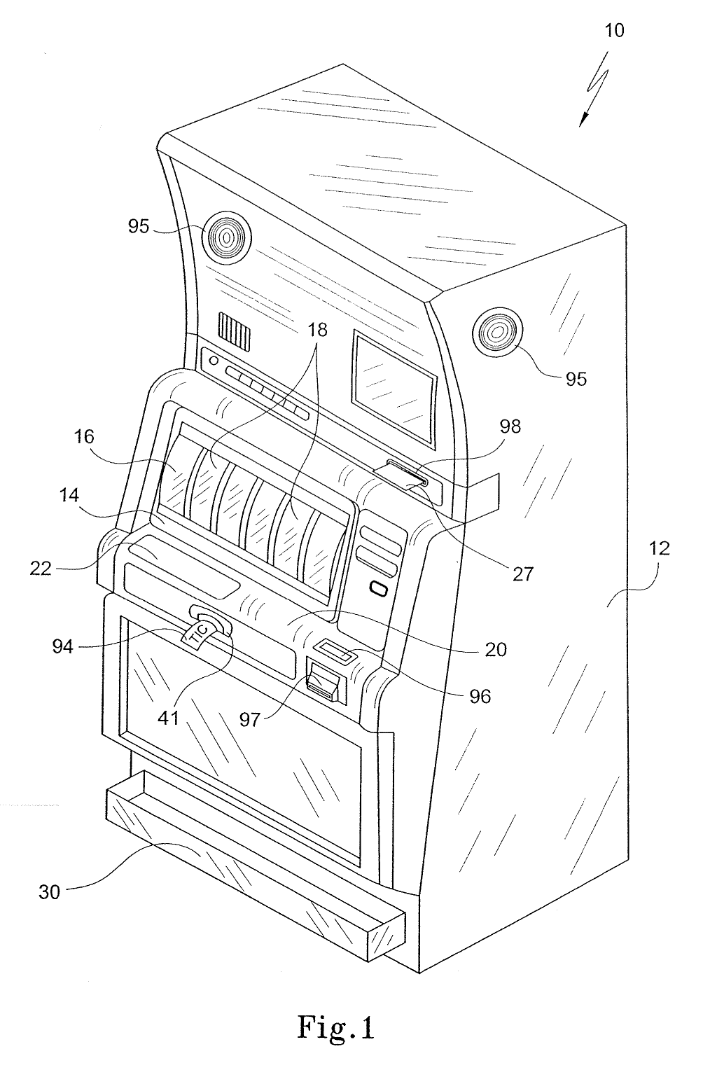

Referring to FIG. 1 a typical gaming machine is illustrated of a type to which the present game method can be applied. The machine illustrated in FIG. 1 is of a type that allows credit input by insertion of coins or bills but the method can also be applied to machines that only allow credit input by transfer of credit from a central cashier or from another gaming machine. In FIG. 1, reference numeral 10 generally designates a gaming machine, including a game or games to be played by a player of the machine. The machine 10 includes a machine 12 having a display means in the form of a video display unit 14 on which a game 16 is played. The video display unit 14 may be implemented as a cathode ray screen device, a liquid crystal display, a plasma screen, or the like. The game 16 as illustrated in FIG. 1 is a spinning reel game which simulates the rotation of a number of spinning reels 18, however many other styles of game are also possible.

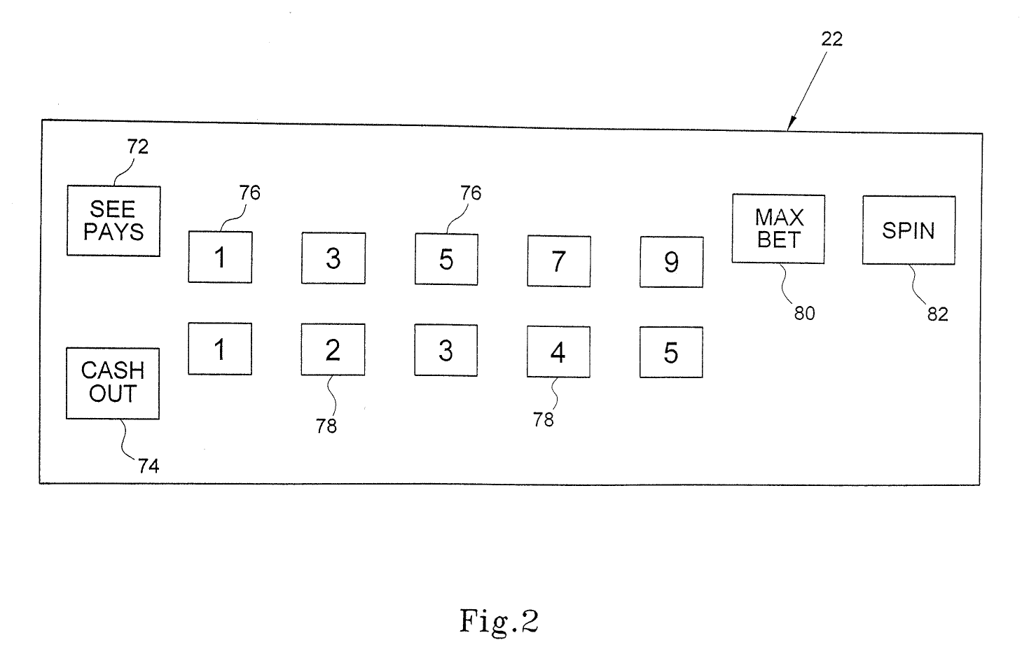

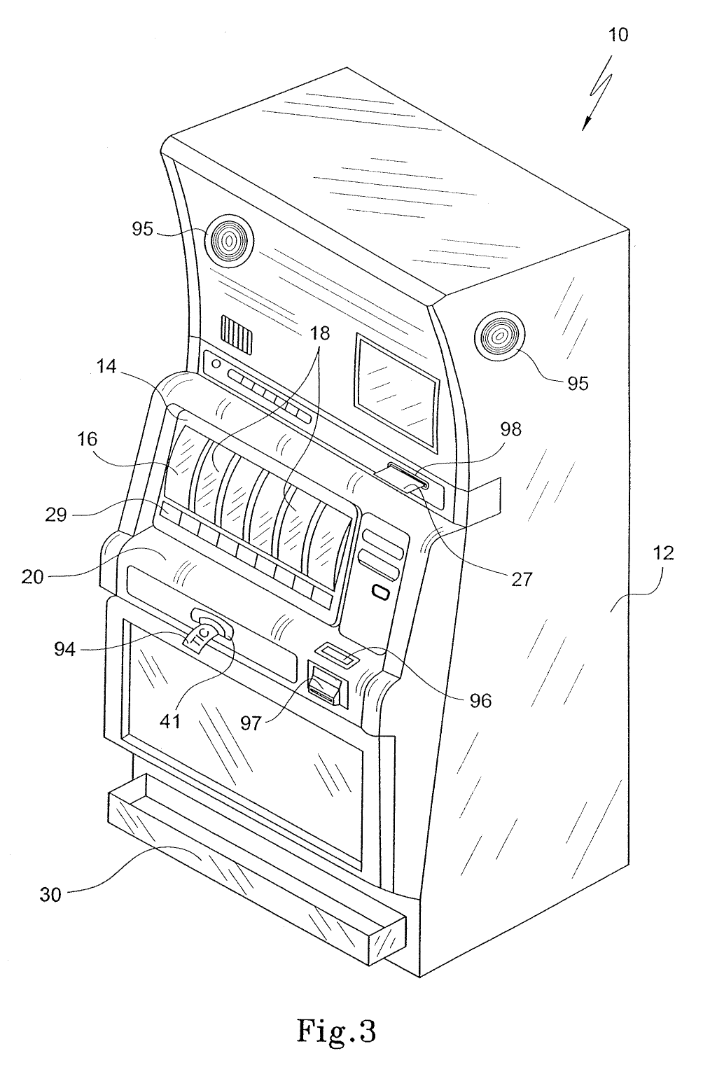

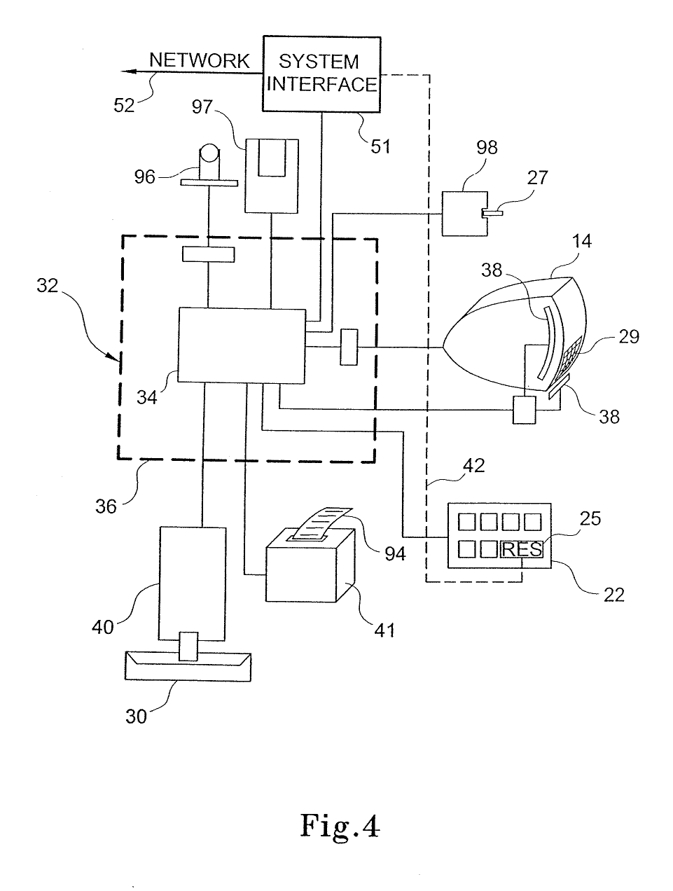

A mid-trim 20 of the machine 10 optionally houses a keypad 22 (shown in greater detail in FIG. 2) for enabling a player to play the game 16. The mid-trim 20 also houses credit input mechanisms including a coin input chute 96 and a bill Acceptor 97. As illustrated in FIG. 3, some gaming machines use a touch screen for player input, in which case the keypad 22 would not be required on the mid-trim in those machines. Instead the keys of the keypad 22 of the FIG. 1 machine would be replaced by screen touch sensors on the machine of FIG. 3 where the keypad is represented as a graphic image 29 on the screen 14 and touch sensors 38 (refer to FIG. 4) located adjacent the screen surface would detect touching of the screen to record player selections. In all other respects the machines of FIGS. 1 and 3 are essentially functionally identical.

A coin tray 30 is mounted beneath the machine 12 for cash payouts from the machine 10 and the housing 12 may include one or more audio speakers 95. The audio speakers 95 may generate audio representing sounds such as the noise of spinning slot machine reels, a dealer's voice, music, announcements or any other audio related to a casino game.

In machines employing the present invention the machine may also be connected via a computer network to other gaming machines and a system controller in which case player profiles may be saved on the system controller and credits can be applied to and cleared from the machine via the network. The credits can either be established at a cashier's station and transferred to the machine or alternatively a player might already have credits in another machine in the network and which they may wish to transfer to a new machine that they wish to play.

To enable the secure transfer of cash to a machine, each machine is provided with a card reader 98 and the player is issued with a player tracking card 27 either when entering the premises or when establishing credit in the system. This tracking card 27 is inserted into the card reader 98 of a machine by the player after the player has established a credit on the system and has had the credit transferred to the desired machine.

The gaming unit 10 may also be provided with a ticket reader/printer 41 which may be used to read and/or print or otherwise encode ticket vouchers 94. The ticket vouchers 94 may be composed of paper or another printable or encodable material and may have one or more of the following informational items printed or encoded thereon: the casino name, the type of ticket voucher, a validation number, a bar code with control and/or security data labelled user check-boxes, labelled user write-in boxes, the date and time of issuance of the ticket voucher, redemption instructions and restrictions, a description of an award, and any other information that may be necessary or desirable. Different types of ticket vouchers 94 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 94 could be printed with an optically readable material such as ink, or data on the ticket vouchers 94 could be magnetically encoded. The ticket reader/printer 41 may be provided with the ability to both read and print ticket vouchers 94, or it may be provided with the ability to only read or only print or encode ticket vouchers 94. In the latter case, for example, some of the gaming units 10 may have ticket printers 41 that may be used to print ticket vouchers 94, which could then be used by a player in other gaming units 10 that have ticket readers.

If provided, the card reader 98 may include any type of card reading device, such as a magnetic card reader or an optical card reader, and may be used to read data from a card offered by a player, such as a credit card or a player tracking card. If provided for player tracking purposes, the card reader 58 may be used to read data from, and/or write data to, player tracking cards that are capable of storing data representing the identity of a player, the identity of a casino, the player's gaming habits, etc.

A value input device may include any device that can accept value from a customer, and may include ticket and card readers, coin slots and bill acceptors. As used herein, the term “value” may encompass gaming tokens, coins, paper currency, ticket vouchers, credit or debit cards, smart cards, and any other object representative of value.

FIG. 2 illustrates one possible embodiment of the control panel 22, which may be used where the gaming unit 10 is a slot machine having a plurality of “virtual” reels. Referring to FIG. 2, the control panel 22 may include a “See Pays” button 72 that, when activated, causes the display unit 14 to generate one or more display screens showing the odds or payout information for the game or games provided by the gaming unit 10. As used herein, the term “button” is intended to encompass any device that allows a player to make an input, such as an input device that must be depressed to make an input selection or a display area that a player may simply touch. The control panel 22 may include a “Cash Out” button 74 that may be activated when a player decides to terminate play on the gaming unit 10, in which case the gaming unit 10 may return value to the player, such as by returning a number of coins to the player via the payout tray 30.

If the gaming unit 10 provides a slots game having a plurality of reels and a plurality of paylines which define winning combinations of reel symbols, the control panel 22 may be provided with a plurality of selection buttons 76, each of which allows the player to select a different number of paylines prior to spinning the reels. For example, five buttons 76 may be provided, each of which may allow a player to select one, three, five, seven or nine paylines.

If the gaming unit 10 provides a slots game having a plurality of reels, the control panel 22 may be provided with a plurality of selection buttons 78 each of which allows a player to specify a wager amount for each payline selected. For example, if the smallest wager accepted by the gaming unit 10 is a quarter ($0.25), the gaming unit 10 may be provided with five selection buttons 78, each of which may allow a player to select one, two, three, four or five quarters to wager for each payline selected. In that case, if a player were to activate the “5” button 76 (meaning that five paylines were to be played on the next spin of the reels) and then activate the “3” button 78 (meaning that three coins per payline were to be wagered), the total wager would be $3.75.

The control panel 22 may include a “Max Bet” button 80 to allow a player to make the maximum wager allowable for a game. In the above example, where up to nine paylines were provided and up to five quarters could be wagered for each payline selected, the maximum wager would be 45 quarters, or $11.25. The control panel 22 may include a spin button 82 to allow the player to initiate spinning of the reels of a slots game after a wager has been made.

In FIG. 2, a rectangle is shown around the buttons 72, 74, 76, 78, 80, 82. It should be understood that that rectangle simply designates, for ease of reference, an area in which the buttons 72, 74, 76, 78, 80, 82 may be located. Consequently, the term “control panel” should not be construed to imply that a panel or plate separate from the housing 12 of the gaming unit 10 is required, and the term “control panel” may encompass a plurality or grouping of player activatable buttons.

Although one possible control panel 22 is described above, it should be understood that different buttons could be utilized in the control panel 22, and that the particular buttons used may depend on the game or games that could be played on the gaming unit 10.

Referring to FIG. 4 of the drawings, a control means or control circuit 32 is illustrated. A program which implements the game and player interface, is run on a processor 34 of the control circuit 32. The processor 34 forms part of a controller 36 that drives the screen of the video display unit 14 and that receives input signals from player inputs such as the optional keypad 22 (see FIG. 1) or the optional sensors 38 associated with the pseudo-keypad 29. The sensors 38, if used, include touch sensors mounted in the screen of the video display unit 14 and associated with the representation of pseudo-buttons of the keypad 29, displayed on the display 16, thereby replacing the buttons of the keypad 22 and replicating their function. The controller 36 also receives input pulses from a number of credit input devices, 96, 97, 98 to determine whether or not a player has provided sufficient credit to commence playing. Slot machines typically have several credit input devices such as a coin input chute 96, a bill collector 97, and a card reader 98 or any suitable other type of currency or credit validation device. In some embodiments of the present invention a player tracking input device is provided, such as the card reader 98, that can be used to associate a particular player with a particular player profile and optionally a credit held in the system (either as data held in a machine or in the system controller or possibly in a further controller reserved for financial information). Note that player tracking does not require knowing the actual identity of the player but is only used to associate the player with a particular player profile and/or credit. This is achieved in the preferred embodiment by using a player tracking card 27, which is a simple magnetic stripe card encoded with a unique code, that may be issued to the player either when they enter the establishment or when they establish a credit in the system and is read by the card reader 98. However other methods of player identification can be employed in tracking systems such as pin numbers, scannable tags of various known types such as magnetic stripe cards, smart cards, etc, iris recognition, finger prints or other bio-sensor systems.

Finally, the controller 36 optionally drives a payout mechanism which, for example, may be ticket printer 41, or a coin hopper 40 for feeding coins to the coin tray 30 to make a pay out to a player when the player wishes to redeem his or her credit. Again however, in embodiments of the present invention, a payout mechanism is not essential as the player may remove the credit held in the machine by transferring it to another machine or to a cashier.

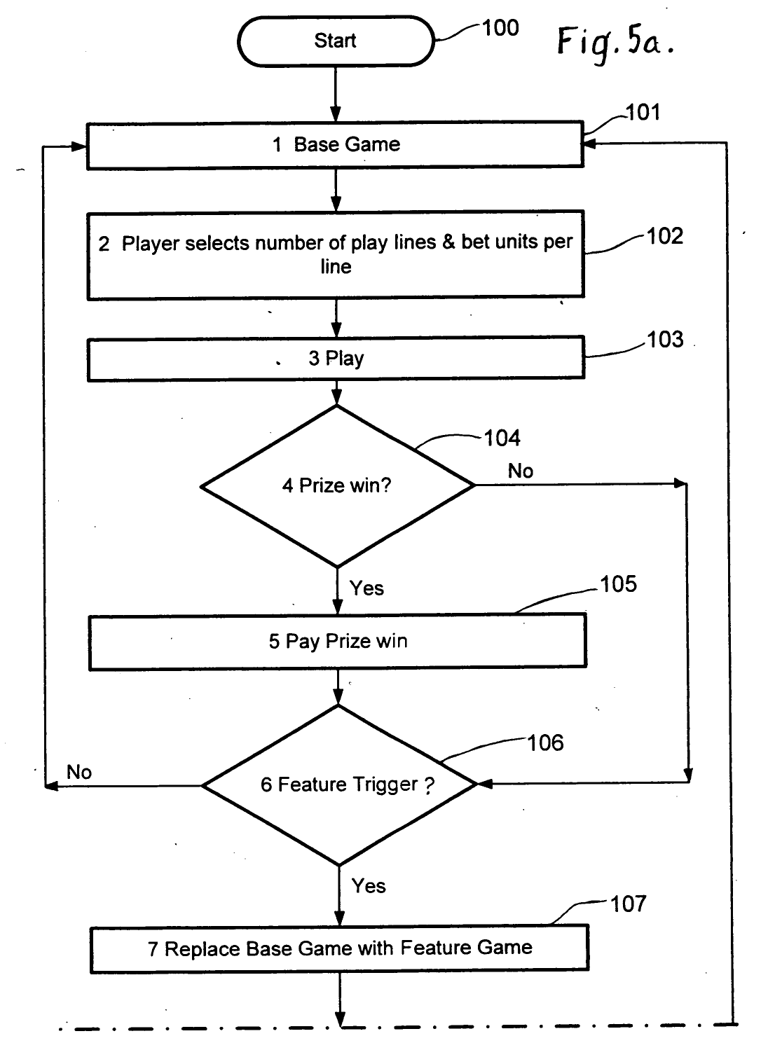

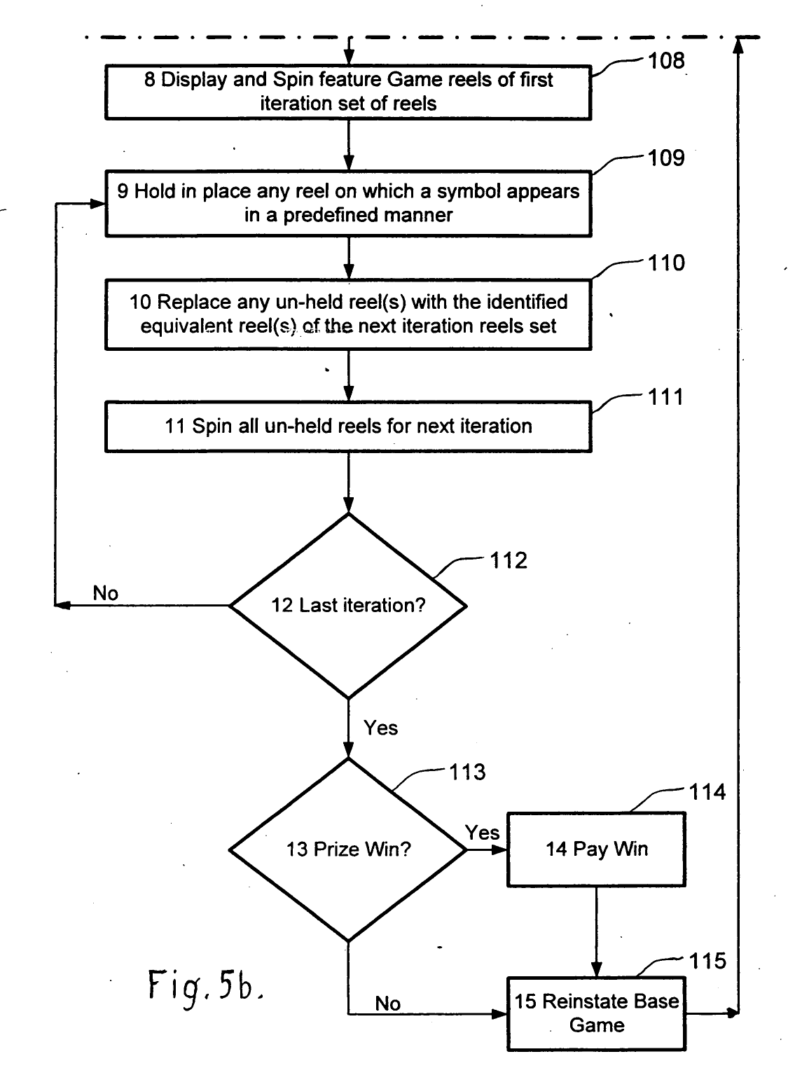

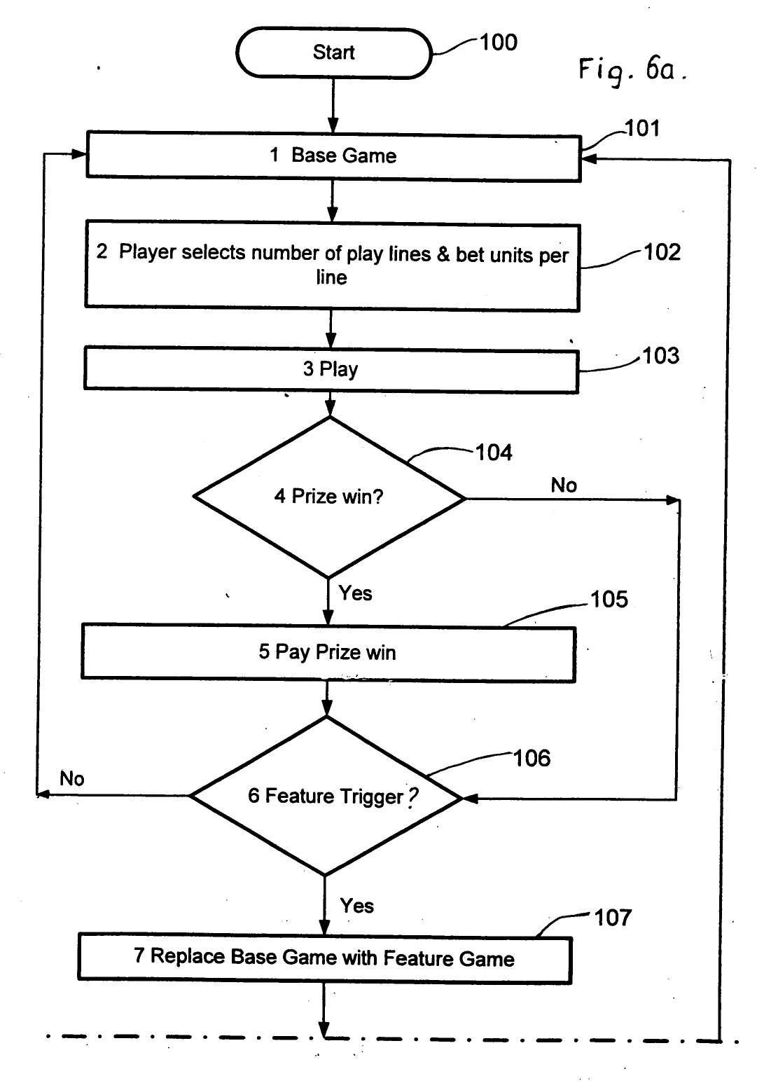

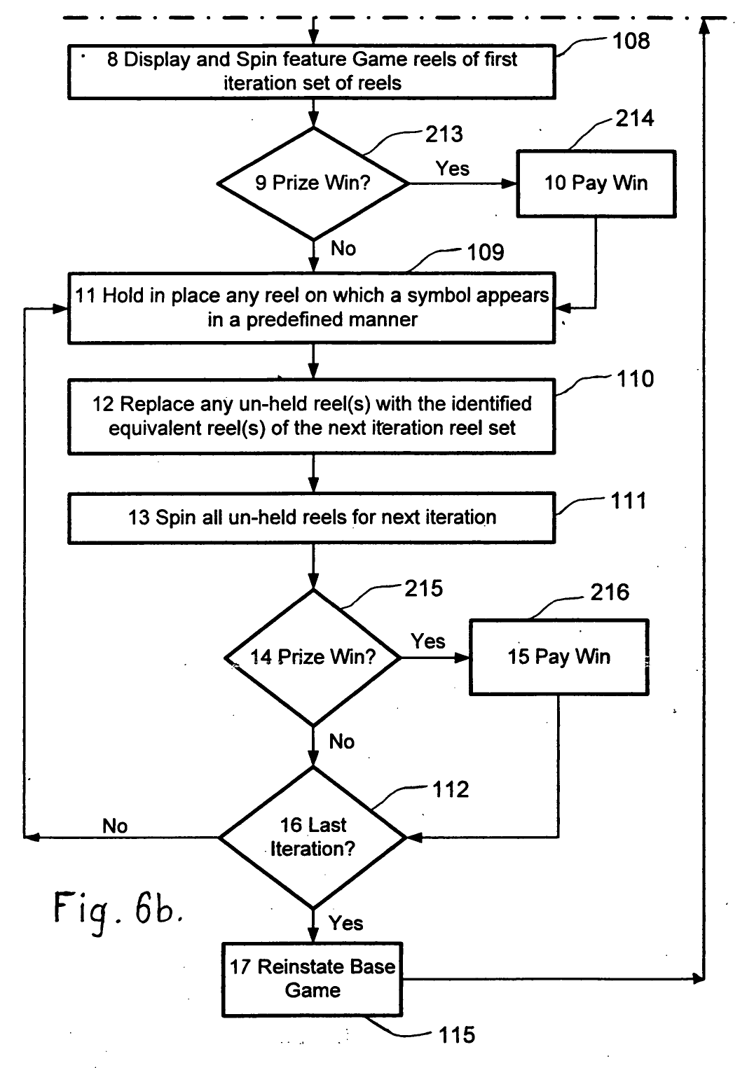

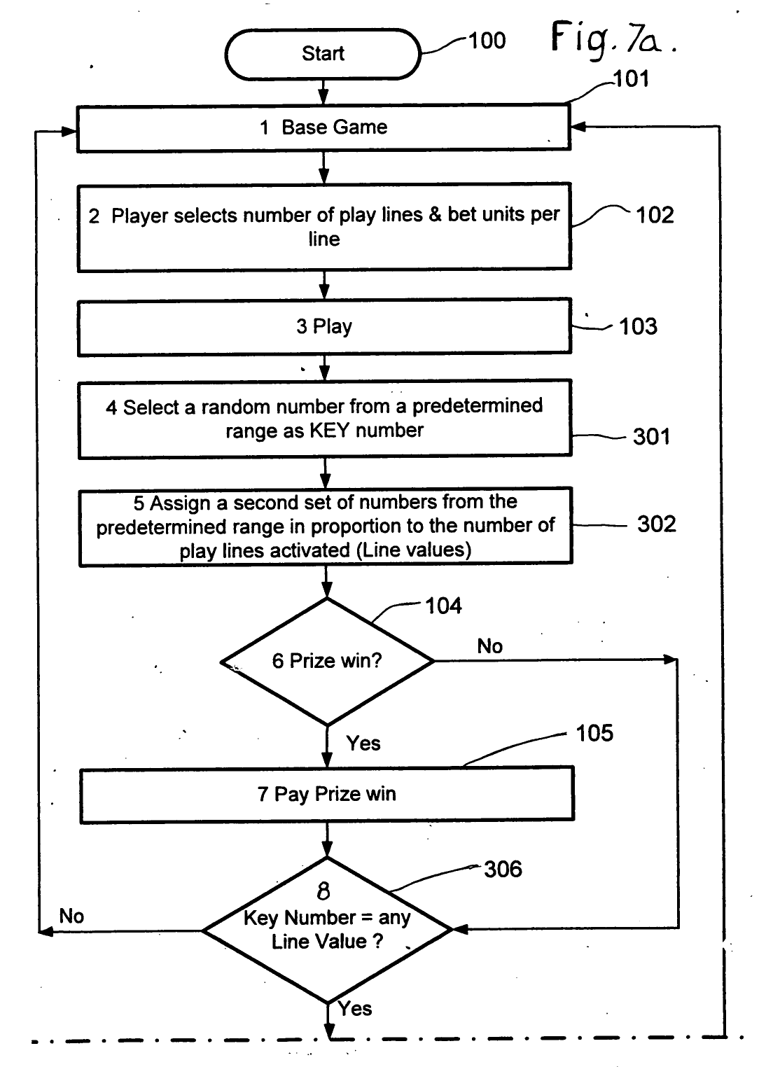

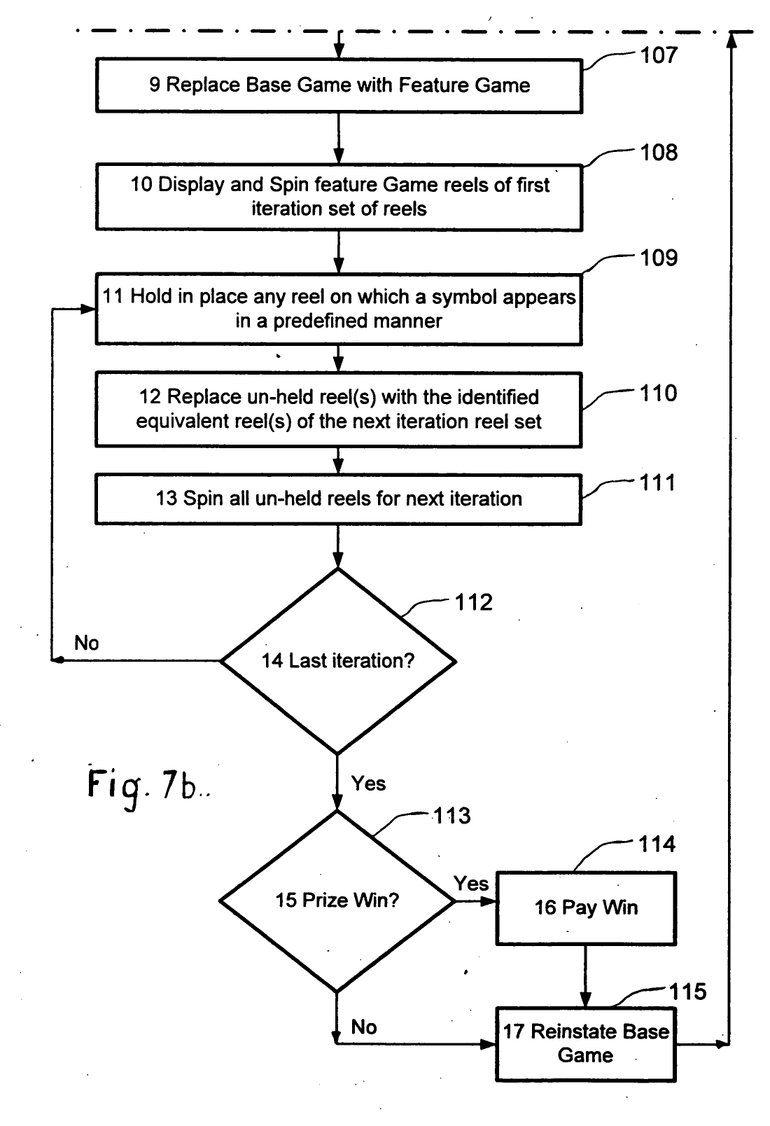

Attached flowcharts shown in FIGS. 5 and 6 illustrate two methods of implementing a first preferred embodiment of a feature game phase, while FIG. 7 shows a flowchart illustrating a method of implementing an alternative triggering method for a feature game phase.

The difference between the two methods illustrated in FIG. 5 and FIG. 6 is in the payout method employed during the Feature game phase.

The first method illustrated by FIG. 5 might be described as the “end pay” method. Its characterising feature is that the evaluation for a payout event occurs at the end of the feature game phase. For example with a 3 stage respin, there is no evaluation for prize-winning combinations at the conclusion of the first respin; and there is no prize evaluation at the conclusion of the second respin. Because the third respin is the last element of the feature the evaluation is made at a point after the third respin has concluded. That is, the evaluation is done at the end of all of the respins—hence the tag: “end pay”. By extension, when a feature phase is designed with 4 respins, there is no prize evaluation (or payment possibility) at the conclusion of the first, second, or third respin. In this case, the evaluation (and payment, if required) is only done at the conclusion of the fourth respin.

The second method illustrated in FIG. 6 describes evaluation and payment, if eligible, being done after each respin. It could be described as the WAYG method (Win as You Go).

The flowchart of FIG. 5 describes the “end pay” method at steps 112 to 114 of the diagram. The WAYG method is described in flowchart FIG. 6 at steps 215 and 216.

Referring to FIG. 5, the machine is initialized 100 (Start) and a base game 101 is offered to the player. To play the base game, the player selects 102 a number of lines to play and places a wager on each selected line. Play is then initiated 103, by pressing a play button on the machine, and after the reels have spun and stopped, the outcome is evaluated 104 for a prize win. If a prize winning outcome has occurred, a prize is paid 105 and the outcome is evaluated 106 for the occurrence of feature triggers in the base game outcome. If no feature triggers occur, the machine offers 101 a new base game to the player.

On the other hand, if a feature trigger has occurred, the base game is replaced 107 with a feature game, having different reel strips to the base game (though they may use a symbol from the base game as main jackpot winning symbol). A first set of reel strips of the feature game are then spun 108 (first respin). After the first respin 108, any reels showing a winning combination are held 109 and the reel strips of the un-held reels are replaced 110 before being respun again 111. After each respin 111, the game tests 112 to determine if the last respin was the last iteration and if not, steps 109, 110, 111 & 112 are repeated until the last respin is performed. Once the respinning is completed, the outcome is tested 113 to determine if it is a prize winning outcome and if so a prize is awarded 114 before reinstating 115 the base game.

Referring to FIG. 6 this flowchart shows a base game substantially identical to that shown in FIG. 5, however in this case the feature game evaluates intermediate outcomes for winning combinations. Therefore after the first respin 108, the outcome is tested 213 for winning conditions and if any exist, a prize is awarded 214, and similarly after each subsequent respin 111 the outcome is again tested 215 for winning conditions and if any exist, a prize is awarded 216. Otherwise, the game of FIG. 6 is essentially identical to that of FIG. 5.

1. The Concept of the Free Respin.

In the WAYG prize evaluation methodology illustrated in the flowchart of FIG. 6, if as a result of the first feature phase ‘respin’ all the reels qualify to be held (not spun) in subsequent ‘respins’ or iterations, the result is nonetheless evaluated in subsequent iterations which plainly do not involve actual reel spins. Let's say that the feature phase pays a prize of 200 units for a 5 Kind outcome. Table 5 shows what will happen with WAYG if a5 of a kind occurs in the first free iteration when all reels are spun:

Assume a 5 reel game; Assume 3 free respin iterations are to be played.

TABLE 5

| Iteration | Reels | Reels | | Prize |
|---|---|---|---|---|
| Number | Held | Spun | Outcome | Paid |
| 1 | 0 | 5 | 5 of a Kind | 200 |
| 2 | 5 | 0 | 5 of a Kind | 200 |
| 3 | 5 | 0 | 5 of a Kind | 200 |

The feature phase would pay a total of 600, 200 for each iteration.

A free respin is NOT determined by whether a reel spin is actually displayed, but by whether there is a prize-evaluation step; if there are 5 free ‘respins’, there must be 5 prize-evaluation steps executed in the WAYG methodology.

To further illustrate with reference to Table 6, assume the following:
Number of free games=5

Prizes are paid for 3 Kind (25), 4 Kind (50), 5 Kind (200).

TABLE 6

| Game | Reels | Reels | | Prize |
|---|---|---|---|---|
| Number | Held | Spun | Outcome | Paid |
| 1 | 0 | 5 | 1 of a Kind | 0 |
| 2 | 1 | 4 | 3 of a Kind | 25 |
| 3 | 3 | 2 | 3 of a Kind | 25 |
| 4 | 3 | 2 | 4 of a Kind | 50 |
| 5 | 4 | 1 | 5 of a Kind | 200 |

The feature phase of Table 6 would pay a total 300.

In contrast, when the END method is used, Table 5 would result in a total prize payout of 200 (not 600 as with WAYG); Table 6 would result in a total prize payout of 200 (not 300). This is because the END method only pays a prize at the conclusion of the last free game.

Table 7 illustrates the result with the END pay method in the circumstances discussed above for Table 5.

TABLE 7

| Game | Reels | Reels | | Prize |
|---|---|---|---|---|
| Number | Held | Spun | Outcome | Paid |
| 1 | 0 | 5 | 5 Kind | 0 |
| 2 | 5 | 0 | 5 Kind | 0 |
| 3 | 5 | 0 | 5 Kind | 200 |

and Table 8 illustrates the result with the END pay method in the circumstances discussed above for Table 6.

TABLE 8

| Game | Reels | Reels | | Prize |
|---|---|---|---|---|
| Number | Held | Spun | Outcome | Paid |
| 1 | 0 | 5 | 1 Kind | 0 |
| 2 | 1 | 4 | 3 Kind | 0 |
| 3 | 3 | 2 | 3 Kind | 0 |
| 4 | 3 | 2 | 4 Kind | 0 |
| 5 | 4 | 1 | 5 Kind | 200 |

FIG. 7 illustrates a flow chart showing another alternative embodiment, which is again similar to the game of FIG. 5. However in this case the feature game trigger is a random trigger which will be described in detail later. As with the FIG. 5 embodiment, an evaluation 306 is performed for the occurrence of the random event that will trigger a feature game. If the feature trigger does not occur, the machine offers 101 a new base game to the player.

On the other hand, if a feature trigger has occurred, the base game is replaced 107 with a feature game, having different reel strips to the base game and the feature game is played as per the FIG. 5 embodiment.

Embodiments of the present game assume that the game is displayed via a video display on which pseudo-reels can be displayed. This is so because of the requirements of implementing the feature phase. The replacement of the base game reels strips with specially designed and different strips is not feasible with physical reel games.

Games typically have two phases:
1) a base game phase; and
2) a feature game phase.

This is a well known game architecture. The base game is the normal game that permits players to wager bets on game outcome(s). When predefined events occur in the base game they act as triggers to suspend the base game and initiate the feature game or phase.

The present game has this same basic architecture. It differs from the norm in the manner in which triggers occur and in the bases and procedures of the feature respins. These differentiating characteristics are explained in the following sections.

One possible form of base game has a number of properties as follows:
a. Players may choose to activate more than one play line per game,
b. Players may choose to wager more than 1 bet unit per play line,
c. Prizes are paid on the occurrence of a predefined linear combination(s) of symbols on an active play line, and/or on the occurrence of predefined non-linear combination(s) of symbols in a game.
d. Some predefined linear combinations of symbols are defined as Feature Phase triggers;
e. Optionally, but only in addition to linear defined triggers (as in d. above), non-linear combinations of symbols may be predefined as feature phase triggers.
f. Feature Phase linear triggers can occur on any active play line,
g. The occurrence of a Feature Phase trigger immediately activates the Feature Phase.
h. Immediately following the occurrence of a trigger, the specific symbol (and/or its substitute) used in the feature phase is selected according to predefined game rules.
i. If more than 1 defined trigger occurs in a single game, feature phase implementations equal to the number of distinct triggers are serially activated.

Items a, b and c above describe the traditional multi-line spinning reel gaming console.

In this embodiment, some feature phase triggers may be defined as linear events or occurrences. This takes advantage of the frequency per game multiplier. This frequency multiplier simply means that the more lines activated in a game, the more frequently will linear defined trigger events occur per game. (illustrated in Table 2 above).

Item e. describes an option that only exists conditionally. If linear triggers are defined, then non-linear triggers may also be defined (e.g. ‘Scatter’ symbol combinations). Embodiments can be formulated which permit both types of triggers to coexist in a game design. It is envisaged that linear triggers can also exist alone; but it is not envisaged that non-linear triggers may exist alone.

Item f. is important in not restricting linear triggers to less than all activated play lines. In short, it doesn't matter how many play lines are activated in a game. ALL activated play lines can fertilise a linear trigger condition. Whenever a defined linear trigger occurs on an active play line, irrespective of which one, the trigger event is recognized.

If a predefined non-linear trigger event occurs in a game, the number of activated play lines is irrelevant. The trigger condition is recognized.

Item g. The occurrence of a trigger immediately puts the game into the feature phase.

Item h. The game rules as applied to the feature phase define which symbol is to be used during the feature phase. Examples of the different types of selection criteria are documented below. Essentially, selection is based on probability values associated with each selectable symbol. The probability values may be determined by base game properties.

Item i. If more than 1 trigger event occurs, the additional ones are queued such that when the feature phase caused by the first trigger is completed, the next trigger effect begins immediately with another feature phase. Simultaneity of triggers does not result in any loss of feature phase implementations.

Feature Phase Properties:
a. Prizes are paid according to game rules on the occurrence of a predefined combination of the selected symbol (and/or its substitute).
b. The Feature Phase consists of a predefined plurality of free games or respins,

Mathematically, what happens in a feature process is a conditional state that exists as an extension of the game that triggered the process in the first place. To describe feature processes as ‘free games’ is imprecise because of the word ‘games’, not because of the word ‘free’. What happens is ‘free’ because prepayment of the base game includes a right to the game extension(s) if a trigger event occurs.

Despite this, there is utility in using the phrase ‘free games’. This utility is based on common usage. For example, U.S. Pat. No. 6,491,584 describes a “ . . . series of free games . . . ” following a “trigger condition”.

In the preferred embodiment it is intended that the feature phase is based on multiple free games. The feature phase employs an “incremental hold and spin” process. As it is not envisaged that the winning symbol will spin up on all reels during the first spin of the feature phase, it is inevitable in this embodiment that the incremental hold and spin process will result in a plurality of free games or respins although it is conceivable that an embodiment can be designed that might on occasion achieve only one spin in the feature phase.
c. The Feature Phase games or respins use a predefined set of (one or more) reels for each predefined respin

Just how many reel strips are used in each of the respins is predefined in the game rules.

Configuration of the Feature Phase

d. Each game or respin is assigned a specific set of reels such that:
   i. The number of symbol positions on each reel strip is predefined
   ii. The symbols positions on each reel strip of each set of reels are populated by a single symbol (and/or its substitute) with provision for some symbol positions on each predefined reel strip to have no symbol assigned
   iii. The individual reel strips within each set of reel strips are identified with an identification method such that the replacement of a particular reel strip in any subsequent respin is always done by one with the same identification within the reels set of that subsequent respin.

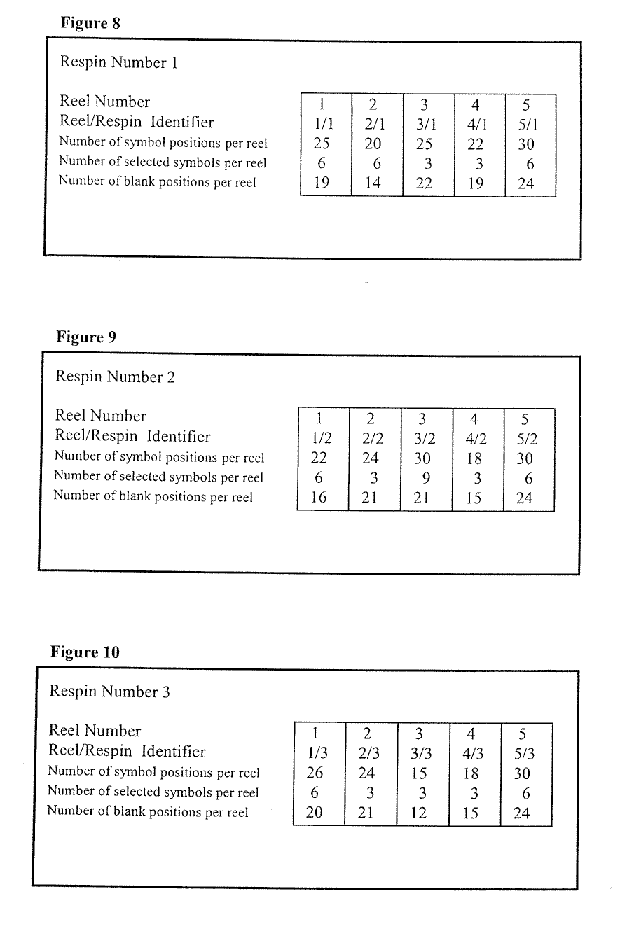

FIGS. 8 to 10 illustrate a general overview of the assignment of specific sets of reels to each of the respins. They are resting on the assumptions of a feature phase with 3 respins and 5 reels being predefined.

Each figure specifies:

a. A reel number for each of the reel strips.
b. A Reel/Respin Identifier in the general depiction of n/y where n refers to the reel number and y refers to the respin number. For example the identifier 4/2 refers to the 4^{th} reel of respin number 2.
c. The number of symbol positions per reel simply refers to the predefined number of symbol positions assigned to each reel strip of each of the respins of the feature phase.
d. The number of selected symbols per reel describes how many symbol positions are populated by a particular symbol (“ . . . and/or its substitute . . . ”). The selection of the symbol referred to here is done according to the pre-designed game rules that apply to the symbol-selection of the feature phase. There are a number of ways that this feature phase symbol selection may be done. Game A described below uses as the selected symbol the symbol of the Base game that triggered the feature phase.
e. The number of blank positions per reel refers to the symbol positions of each of the reel strips on which no symbol appears.
f. The first free game or respin of a Feature Phase consists of spinning all the reels of the 1st respin set of reels once
g. After each respin, any reel strip displaying a symbol in a predefined manner is held in place for the duration of the feature phase
h. Subsequent to the 1^{st} respin, each respin spins un-held reels once in accord with:
   i. Any reel which displays a symbol in a predefined manner is held in place for the duration of the Feature Phase
   ii. Any reel which is not held in place is replaced by the identically tagged reel strip from the set of reels of the next respin
   iii. At the completion of the last respin, the symbols on display are evaluated for any prize-winning combination
   iv. If a prize is payable, it is paid according to the rules applying to the Feature Phase

### The Second Preferred Embodiment

The difference between the 1st and 2nd embodiments stems from the triggering method used in the 2nd embodiment.

The elements of the 1st method that have been cut from the description of the 2nd method are items e, f and i.

These 3 elements have been rendered illogical by the following new element:
A predefined event is constructed as the Feature Phase trigger by the generation of two sets of numbers such that:
   i. When the base game is initiated a random number (the KEY number) is selected from a predefined range,
   ii. A second set of numbers (PLAY numbers) from the same predefined range are assigned in proportion to the number of play lines activated in the base game,
   iii. Whenever a PLAY number equals the KEY number, the Feature Phase is triggered.

With this methodology, the necessary ‘linearity effect’ is preserved by correlating the number of PLAY numbers generated to the number of play lines activated in a game.

Use of this triggering method makes it impossible to experience simultaneous triggers in a game. Additionally, anything that happens on an active play line in the base game has nothing to do with the triggering process.

Incremental Hold and Spin Method.

The following illustrates the method using a 5 column 3 row display with the “B” symbol being the chosen symbol for the particular illustration. 3 respins are played in this particular description. On these bases, there are 1,024 different paths to a final outcome. What is illustrated is but 1 of those paths.

FIG. 11 represents an optional initial step in the process of presenting the Feature games or respins in which the reels are displayed stationary with no B symbols showing. It may be omitted in which case the first spin of the feature phase is initiated from the final state of the reels in the base game.

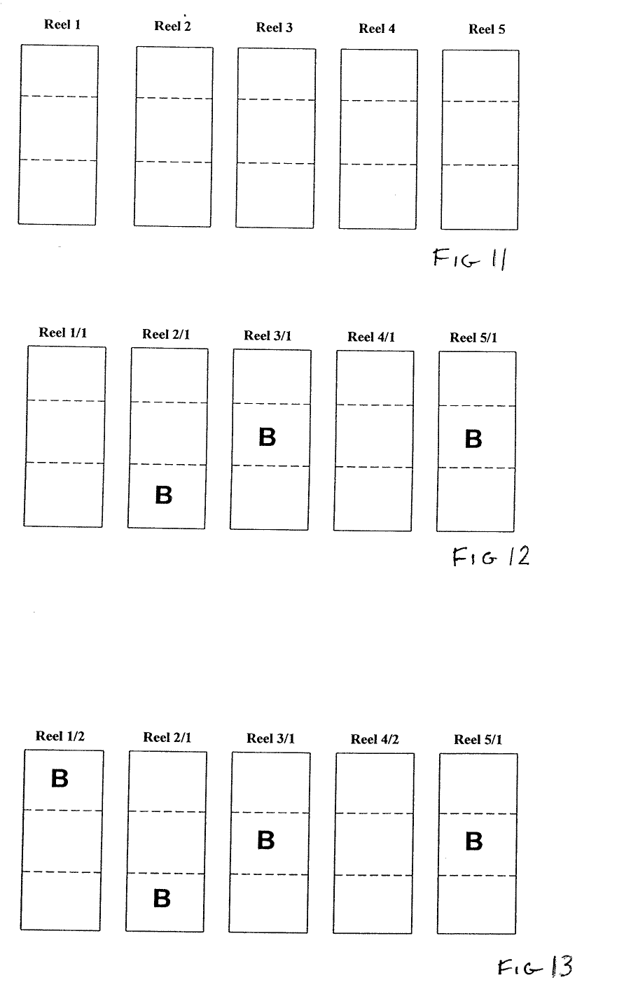

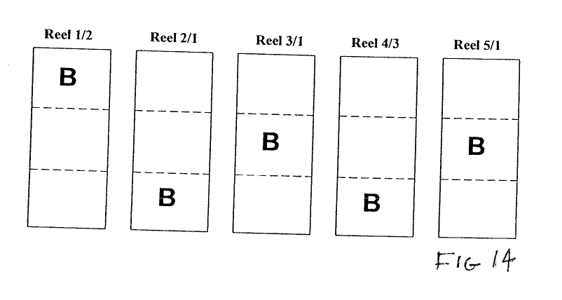

FIGS. 12 and 13 show subsequent states for each reel after 1st and 2nd respins. After each respin the reel strips of each reel are replaced with new reel strips each having an identification which can be generically described as “Reel n/y” where n identifies an identification number specific to a single reel strip and y further identifies the respin number of the reels set to which the same specific reel strip belongs. For example, in FIG. 12, the reel strip header “Reel 2/1” refers to reel strip number 2 of the 1^{st} respin reels set. The header in FIG. 14 “Reel 4/3” means that reel strip is identified as reel number 4 of the reels set of respin 3.

The result of 1st Respin is illustrated in FIG. 12. After the first respin, the reels displaying “B” symbols, which are identified as reels 2/1, 3/1 and 5/1, are HELD in place for the remaining duration of the Feature phase. The displayed reels 1/1 and 4/1 are then replaced by reels of the 2nd respin set identified as 1/2 and 4/2 when the 2nd respin begins.

After the second respin, the displayed reels identified as 1/2, 2/1, 3/1, and 5/1 (see FIG. 13) are now HELD in place for the remaining duration of the Feature phase. The displayed reel identified as 4/2 is replaced by the reel of the 3rd respin set identified as 4/3 when the 3^{rd} respin begins.

The result of the 3rd and final Respin is illustrated in FIG. 14. Once the state shown in FIG. 14 is reached, the Feature Phase is now complete.

After the 3rd respin the final result is evaluated for prize-winning status. If a prize is payable, payment is made at this point.

The Base game is reinstated at this point as shown in the flowcharts of FIGS. 5, 6 and 7 at step 115.

The process described in the above illustration is the first preferred method wherein the prize evaluation is done at the completion of the last respin: the “End Pay” method outlined in the flowchart of FIG. 5.

The second preferred method is identical save for the prize evaluation process. This second method evaluates for prizes at the completion of each of the respins, using the WAYG method as outlined with reference to the flowchart in FIG. 6.

Game Presentation Considerations

The Feature phase operation using the incremental hold and spin process presents an arresting visual series of steps to a player. The series enables a player to observe a sequence of events each step of which can improve standing in respect of winning a prize or improving an existing prize-winning state. By way of illustration, with a design using 5 reels and 3 respins, only 1 outcome path out of 1,024 can result in a nil advance to 1 or more held symbols. The full listing is shown in Table 9 below:

TABLE 9
Theoretical

| Outcomes | Number |
|---|---|
| 0 Symbols | 1 |
| 1 Symbol | 15 |
| 2 Symbols | 90 |
| 3 Symbols | 270 |
| 4 Symbols | 405 |
| 5 Symbols | 243 |
| Total | 1,024 |

The weighting towards high frequency outcomes underpins the player entertainment value of the method. The high symbol-frequency of theoretical outcomes as listed are traditionally associated with high prize values thus enhancing the entertainment value for a player.

Game Performance Considerations

There are two principal game performance properties delivered by the games described herein that underpin their advance over existing methods.

Whenever a trigger event occurs in a base game, the automatic implementation of the feature phase carries with it an expectation of value to the player. This expectation is the average win that a player will accrue from the feature phase. In effect this is the average win value of a trigger.

This average win value of a trigger can be starkly illustrated by converting known games that use a non-linear feature triggering method to one using the present method. One such game is “Queen of the Nile™” by Aristocrat™. The version of this game illustrated here has a Return to Player setting of 90.31% and a standard deviation of 13.51. In its original design, this game triggers 15 free games using scatter (i.e., non-linear) events as triggers. In that original form, the average prize value per trigger is 30.04 credit units.

In a modified form of the game, the Feature Phase is replaced with the methods described above (using 3 respins) and the triggers in the base game are linear (4 or 5 of a Kind on any active play line) in place of the non-linear triggers.

The resultant improvement is considerable. In the modified form, the average prize value of a trigger event amounts to 114.64 credit units. This represents a 281.6% increase in favour of the player.

There is a second telling consideration in comparing the original game to the modified one as described above. In the original game, the feature phase is expected to be triggered once every 127.6 games (irrespective of the number of play lines activated). This is a constant: it is the expected value when 1 play line applies, or 5 or 20 lines are activated. In the modified form the feature phase is expected to be triggered once every 29.1 games if 20 play lines were active in the triggering games. As an absolute, this represents a 338.5% improvement in the player's expected entitlement.

Similar results occur with the modification of an IGT™ game called “Amazon Jewel™”. In its original form, “Amazon Jewel” has a Return to Player setting of 90.79% and a standard deviation of 11.61. In its original design, this game triggers 20 free games using non-linear events in the base game as triggers. The average prize value per trigger is 37.6 credit units.

In a modified form of the game, the Feature Phase is replaced with the methods described above (using 3 respins) and the triggers in the base game are linear and non-linear (any 4 or 5 of a Kind) in place of the non-linear triggers.

Once again, the resultant improvement is considerable. In the modified form, the average prize value of a trigger event amounts to 104.2 credit units. This represents a 177.1% increase in favour of the player.

On the second consideration, the feature phase of the original “Amazon Jewel” is expected to be triggered once every 133.8 games. In the modified form the feature phase is expected to be triggered once every 20.9 games if 20 play lines were active in the triggering games. The player's entitlement is 5.4 times superior in the modified form to that of the original.

In summary, the comparisons are shown in Table 10:

TABLE 10

| | Queen of Nile | Queen of Nile |
|---|---|---|
| | Original | Modified |
| Return to Player | 90.31% | 90.22% |
| Standard Deviation | 13.51 | 15.11 |
| 20 Line Hit Rate | 127.60 | 29.10 |
| Average Trigger Value | 30.04 | 114.64 |
| | Amazon Jewel | Amazon Jewel |
| | Original | Modified |
| Return to Player | 90.79% | 90.43% |
| Standard Deviation | 11.61 | 12.79 |
| 20 Line Hit Rate | 133.80 | 20.92 |
| Average Trigger Value | 37.60 | 104.28 |

It might be noted from the above table that the standard deviation may be significantly increased by use of the methods described above. This is relevant to player entertainment and game popularity as discussed earlier.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An electronic gaming machine having a base game comprising a multi-line spinning reel game and a random prize awarding feature to selectively provide a feature outcome, the machine being arranged to offer the feature outcome when a game has achieved a trigger condition, the machine including trigger detection arranged to test for the trigger condition and to initiate the feature outcome comprising a feature game phase when the trigger condition occurs, and the feature game phase characterised in that:
feature game phases each comprise one or more free respins;
feature game phase prizes are paid according to predetermined feature game phase rules;
in a feature game phase all the reels are respun once;
after the first free respin, and after any subsequent free respin, any reel strip displaying a symbol in a predefined manner is held in place for a remainder of the feature game phase;
at the completion of the last respin, the symbols on display are evaluated and if a prize-winning combination exists a prize is awarded according to the rules applying to the feature game phase and the feature phase discontinues and the base game is reinstated.

2. The electronic gaming machine as claimed in claim 1 wherein, at the completion of each respin, the symbols on display are evaluated and if a prize-winning combination exists a prize is awarded according to the rules applying to the feature game phase.

3. The electronic gaming machine as claimed in claim 1 wherein subsequent free respins are initiated to spin un-held reels while there are un-held reels remaining.

4. The electronic gaming machine as claimed in claim 1 or 2 wherein subsequent free respins are initiated to spin un-held reels until a predetermined number of respins have occurred.

5. The electronic gaming machine as claimed in claim 1 wherein a maximum number of respins per feature game phase is no less than two respins.

6. The electronic gaming machine as claimed claim 1 wherein feature outcome respins use a set of reel strips comprising a plurality of predefined reel strips, there being one for each pseudo-reel for each respin wherein each respin is assigned a specific set of reel strips and wherein:
a) the number of symbol positions on each reel strip is predefined; and
b) the symbols positions on each reel strip of each set of pseudo-reels is populated by a single symbol with provision for some symbol positions on each predefined reel strip to have no symbol assigned.

7. The electronic gaming machine as claimed in claim 6 wherein the reel strips for each pseudo-reel, in the set of reel strips, are identified similarly and before each free respin, subsequently to the first respin, any reel which is not held is replaced by a similarly identified reel strip from the next set of reels strips.

8. The electronic gaming machine as claimed in claim 6 wherein a specific single symbol is used in each specific instance of a feature game phase and the specific symbol is selected according to predefined game rules.

9. The electronic gaming machine as claimed in claim 6 wherein the selection of the single symbol occurs immediately following the occurrence of a trigger.

10. The electronic gaming machine as claimed in claim 1 wherein the trigger condition is a combinational trigger, relying on a predefined outcome combination of symbols occurring during a base game.

11. The electronic gaming machine as claimed in claim 1 wherein the trigger condition is a random trigger unrelated to outcome of the base game.

12. A method of operating an electronic gaming machine, wherein the gaming machine has a base game comprising a multi-line spinning reel game and a random prize awarding feature to selectively provide a feature outcome, the method comprising offering the feature outcome when a game has achieved a trigger condition, the machine including trigger detection arranged to test for the trigger condition and the feature outcome comprising a feature game phase, the method comprising initiating the feature game phase when the trigger condition occurs, the method characterised in that:
each feature game phase is operated to provide one or more free respins;
when a prize is won by a player in the feature game phase, the prize is paid according to predetermined feature game phase rules;
when the feature game phase is initiated all the reels are respun once;
after the first free respin, and after any subsequent free respin, any reel strip displaying a symbol in a predefined manner is held in place for a remainder of the feature game phase;
at the completion of the last respin, the symbols on display are evaluated and if a prize-winning combination exists a prize is awarded according to the rules applying to the feature game phase and the feature phase discontinues and the base game is reinstated.

13. The method as claimed in claim 12 wherein at the completion of each respin, the symbols on display are evaluated and if a prize-winning combination exists a prize is awarded according to the rules applying to the feature game phase.

14. The method as claimed in claim 12 wherein subsequent free respins are initiated to spin un-held reels while there are un-held reels remaining.

15. The method as claimed in claim 12 wherein subsequent free respins are initiated to spin un-held reels until a predetermined number of respins have occurred.

16. The method as claimed in claim 12 wherein a maximum number of respins per feature game phase is no less than two respins.

17. The method as claimed in claim 12 wherein feature outcome respins use a set of reel strips comprising a plurality of predefined reel strips, there being one for each pseudo-reel for each respin wherein each respin is assigned a specific set of reel strips and wherein:
a) the number of symbol positions on each reel strip is predefined; and
b) the symbols positions on each reel strip of each set of pseudo-reels is populated by a single symbol (and/or its substitute) with provision for some symbol positions on each predefined reel strip to have no symbol assigned.

18. The method as claimed in claim 17 wherein the reel strips for each pseudo-reel, in the set of reel strips, are identified similarly and before each free respin, subsequently to the first respin, any reel which is not held is replaced by a similarly identified reel strip from the next set of reels strips.

19. The method as claimed in claim 17 wherein a specific single symbol is used in each specific instance of a feature game phase and the specific symbol is selected according to predefined game rules.

20. The method as claimed in claim 17 wherein the selection of the special single symbol occurs immediately following the occurrence of a trigger.

21. The method as claimed in claim 12 wherein the trigger condition is a combinational trigger, relying on a predefined outcome combination of symbols occurring during a base game.

22. The method as claimed in claim 12 wherein the trigger condition is a random trigger unrelated to outcome of the base game.

23. An electronic gaming machine having a base game comprising a multi-line spinning reel game and a random prize awarding feature to selectively provide a feature outcome, the machine being arranged to offer the feature outcome when a game has achieved a trigger condition, the machine including trigger detection arranged to test for the trigger condition and to initiate the feature outcome when the trigger condition occurs, the trigger condition being determined by an event having a probability related to the number of lines played in the respective game.

24. The electronic gaming machine of 23 wherein the testing for the trigger condition is performed during a base game on the machine.

25. The electronic gaming machine of claim 23 or 24 wherein the trigger condition is determined by selecting a random number from a predetermined range of numbers to be associated with each base game, and a set of numbers selected from the predetermined range of numbers is allotted to the game, the size of the set of allotted numbers being related to the number of lines played in the respective game, and in the event that one of the numbers allotted to the game matches the randomly selected number, indicating that the trigger condition has occurred.

26. The method of claim 23 or 24 in which the trigger condition is determined by selecting a random number from a predetermined range of numbers to be associated with each base game, and a set of numbers selected from the predetermined range of numbers is allotted to the game and wherein the size of the set of allotted numbers is inversely related to the number of lines played in the respective game, and in the event that none of the numbers allotted to the game matches the randomly selected number, indicating that the trigger condition has occurred.

27. A method of operating an electronic gaming machine, the electronic gaming machine having a base game comprising a multi-line spinning reel game and a random prize awarding feature to selectively provide a feature outcome, the machine being arranged to offer the feature outcome when a game has achieved a trigger condition, the machine including trigger detection arranged to test for the trigger condition and to initiate the feature outcome when the trigger condition occurs, and the method comprising testing for the trigger condition and initiating the feature outcome when the trigger condition occurs, wherein the trigger condition is determined by occurrence of an event having a probability related to the number of lines played in the respective game.

28. The method of claim 27 wherein the testing for the trigger condition is performed during a base game on the machine.

29. The method of claim 27 wherein the trigger condition is determined by selecting a random number from a predetermined range of numbers to be associated with each base game, and a set of numbers selected from the predetermined range of numbers is allotted to the game, the size of the set of allotted numbers being related to the number of lines played in the respective game, and in the event that one of the numbers allotted to the game matches the randomly selected number, indicating that the trigger condition has occurred.

30. The method of claim 27 in which the trigger condition is determined by selecting a random number from a predetermined range of numbers to be associated with each base game, and a set of numbers selected from the predetermined range of numbers is allotted to the game and wherein the size of the set of allotted numbers is inversely related to the number of lines played in the respective game, and in the event that none of the numbers allotted to the game matches the randomly selected number, indicating that the trigger condition has occurred.
